(19) United States
(12) Patent Application Publication
(10) Pub. No.: US 2025/0105523 A1
(43) Pub. Date: Mar. 27, 2025

(54) Radio Location And Augmented Reality Antenna System

(71) Applicant: Fractal Antenna Systems, Inc., Bedford, MA (US)

(72) Inventors: Nathan Cohen, Belmont, MA (US); Philip Salkind, Boston, MA (US)

(73) Assignee: Fractal Antenna Systems, Inc., Bedford, MA (US)

(21) Appl. No.: 18/895,917

(22) Filed: Sep. 25, 2024

Related U.S. Application Data
(60) Provisional application No. 63/584,992, filed on Sep. 25, 2023.

(51) Int. Cl. H01Q 11/08; G01S 5/02; H01Q 1/22; H01Q 21/00

(52) U.S. Cl. CPC H01Q 11/08; G01S 5/0221; H01Q 1/22; H01Q 21/0087

(57) ABSTRACT

Systems, structures, circuits, and methods provide multi-axis (angular-offset) helical antennas allowing radio location and/or provision of augmented reality imagery and data. Three or more helical antennas have respective axes, which are separated by angles or angular displacements. Such antenna apparatus may be used to coordinate sensors so as to create signs, images, convey data and/or voice, and pinpoint RF targets such as smartphones or other wireless devices with accuracy in venue environments such as stadiums, arenas, theaters, etc.; large outdoor settings such as areas of parks, municipal gathering areas, etc.; and/or other locations/locals.

### RELATED APPLICATIONS

This application claims the benefit of and priority to U.S. Provisional Application No. 63/584,992, filed Sep. 25, 2023, and entitled “Radio Location and Augmented Reality Antenna System,” the entire content of which is incorporated herein by reference.

### BACKGROUND

Radio location systems typically incorporate time of arrival and/or phase data to discern direction and location of a radio frequency (RF) transmitter—such as cellular phones (a.k.a., “cell phones” or “smart phones”)—in a given area. The processes of location are generally referred to as “radiolocation” or “geolocation.” Common radio location techniques include time difference of arrival (TDOA), angle of arrival (AOA), and power of arrival (POA) techniques.

Time difference of arrival (TDOA), also known as multi-lateralization, compares the time difference of a received RF signal (typically the I/Q data of the signal) between multiple receivers. As the receivers are in different locations, they receive the same signal at different times. Precise calculation of this time difference using spectrum monitoring and geolocation software allows the signals to be geolocated. The accuracy of TDOA geolocation is influenced by modulation bandwidth, which is the range of frequencies used by a signal to transmit information.

Angle of arrival (AOA) provides a single line of bearing from a direction finding (DF) antenna or antenna array to a transmitter. The line of bearing can be overlaid on a map or polar chart to indicate where the signal is coming from. The bearing can also be oriented with respect to a particular direction (e.g., True North) or relative to a mobile vehicle.

Power of arrival (POA) is a geolocation technique that compares the amplitude power (of the signal) received by multiple receivers. The technique analyzes and compares the received power levels to establish a location of a transmitter. This method is accurate and fast in line-of-sight (LOS) scenarios but, in contrast to angle of arrival (AOA), requires taking signal level measurements at several locations in order to give a first estimation of the emitter's direction. For non-LOS scenarios, such as those predominating urban environments, the received signal level fluctuates independently of the distance to the emitter because of multipath propagation. As a consequence, POA systems find it difficult to determine the true direction of the emitter.

The noted techniques often suffer from systematic errors, e.g., a lack of redundancy and data, in deriving location, particularly in urban environments. Consequently, the noted techniques may not be adequate, on their own, to achieve precise radio location in urban environments, including residential, commercial buildings, and stadiums.

### SUMMARY

Aspects, examples, and embodiments of the present disclosure are directed to and include systems, circuits, apparatus, and methods providing multi-axis helical antennas useful for radio location and/or providing date for augmented reality applications such as interactive gaming and/or audiovisual presentations/performances.

One general aspect includes a multi-axis helical antenna system. The multi-axis helical antenna system can include: a frame; and a plurality of helical antennas connected to the frame, where each of the helical antennas includes a central axis and a helix configured about the central axis, and where each different pair of helical antennas of the plurality of antennas is separated by a desired angle, respectively.

Implementations may include one or more of the following features. The plurality of helical antennas can be configured for an end-fire radiation mode. The central axes of each adjacent pair of antennas of the plurality of helical antennas can be separated by a desired angle, where the desired angle is in the range of about 15 degrees to about 60 degrees, in some embodiments; other ranges of angles (e.g., about 20 degrees to about 40 degrees) may be employed in other embodiments. The plurality of helical antennas can include three helical antennas in some embodiments; other embodiments may have a different number, e.g., four, five, six, etc. The plurality of helical antennas can be configured such that in operation the antennas are substantially decoupled from one another. Each helix can include a crank line or fractal meander line configuration, in some embodiments. The antenna system may include transmission circuitry configured to supply each of the plurality of helical antennas with RF energy for transmission. The antenna system may include processing circuitry configured to transmit data to one or more targeted RF sources within range of the plurality of helical antennas. In some embodiments, the targeted RF sources may be identified by their ISP addresses, and those addresses may be used for data transmissions to the targeted RF sources. The antenna system may include reception circuitry configured to receive RF energy from one or more target RF sources within range of the plurality of helical antennas. The antenna system may include processing circuitry configured to produce an output signal indicative of a location of one or more RF targets within range of the plurality of helical antennas.

Another general aspect of the present disclosure includes a method of making a multi-axis helical antenna system. The method can include: providing a frame; and providing a plurality of helical antennas connected to the frame, where each of the helical antennas includes a central axis and a helix configured about the central axis, and where each different pair of helical antennas of the plurality of antennas is separated by a desired angle, respectively. Other embodiments of this aspect include corresponding computer systems, apparatus, and computer programs recorded on one or more computer storage devices, each configured to perform the actions of the methods.

Implementations may include one or more of the following features. The plurality of helical antennas can be configured for an end-fire radiation mode. The central axes of each adjacent pair of antennas of the plurality of helical antennas can be separated by a desired angle, where the desired angle is in the range of about 15 degrees to about 60 degrees, in some embodiments; other angle ranges may be employed in other embodiments. The plurality of helical antennas can include three helical antennas, in some embodiments; in other embodiments, different numbers of helical antennas may be employed, e.g., two, four, five, six, seven, etc. The plurality of helical antennas can be configured such that in operation the antennas are substantially decoupled from one another. Each helix can include a crank line or fractal meander line configuration. The method may include providing transmission circuitry configured to supply each of the plurality of helical antennas with RF energy for transmission. The method may include providing processing circuitry configured to transmit data to one or more targeted (e.g., using ISP number) RF sources within range of the plurality of helical antennas. The method may include providing reception circuitry configured to receive RF energy from one or more target RF sources within range of the plurality of helical antennas. The method may include providing processing circuitry configured to produce an output signal indicative of a location of one or more RF targets within range of the plurality of helical antennas.

Embodiments and implementations of the described aspect(s) can include a system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform actions, e.g., as described herein or related to such described actions. Moreover, implementations of the described techniques/technology may include hardware, a method or process, and/or computer software on a computer-accessible medium.

The features and advantages described herein are not all-inclusive; many additional features and advantages will be apparent to one of ordinary skill in the art in view of the drawings, specification, and claims. Moreover, it should be noted that the language used in the specification has been selected principally for readability and instructional purposes, and not to limit in any way the scope of the present disclosure, which is susceptible of many embodiments. What follows is illustrative, but not exhaustive, of the scope of the present disclosure.

### BRIEF DESCRIPTION OF THE DRAWINGS

The manner and process of making and using the disclosed embodiments may be appreciated by reference to the figures of the accompanying drawings. In the figures like reference characters refer to like components, parts, elements, or steps/actions; however, similar components, parts, elements, and steps/actions may be referenced by different reference characters in different figures. It should be appreciated that the components and structures illustrated in the figures are not necessarily to scale, emphasis instead being placed upon illustrating the principals of the concepts described herein. Furthermore, embodiments are illustrated by way of example and not limitation in the figures, in which:

FIG. 1A shows an example multi-axis helical antenna system in accordance with the present disclosure;

FIG. 1B is an enlarged view of a helical antenna of the antenna system shown in FIG. 1A;

FIG. 2 shows an alternate embodiment of a multi-axis helical antenna system in accordance with present disclosure;

FIG. 3 is a diagram showing steps in an example method of fabricating a multi-axis helical antenna system in accordance with the present disclosure; and

FIG. 4 shows an example computing system in accordance with the present disclosure.

### DETAILED DESCRIPTION

The features and advantages described herein are not all-inclusive; many additional features and advantages will be apparent to one of ordinary skill in the art in view of the drawings, specification, and claims. Moreover, it should be noted that the language used in the specification has been selected principally for readability and instructional purposes, and not to limit in any way the scope of the inventive subject matter. The subject technology is susceptible of many embodiments. What follows is illustrative, but not exhaustive, of the scope of the subject technology.

Aspects, examples, and embodiments of the present disclosure are directed to and include systems, circuits, apparatus, and methods providing multi-axis (angular-offset) helical antennas allowing radio location and augmented reality imagery and data. Such antenna apparatus may be used to coordinate sensors so as to create signs, images, convey data and/or voice, and pinpoint wireless devices with accuracy in venue environments (e.g., stadiums, arenas, theaters, etc.), large outdoor settings (areas of parks, municipal gathering areas, etc.), or other locations/locals.

As noted above, radio location systems typically incorporate time of arrival and or phase data to discern direction and location. Antenna apparatus/systems according to the present disclosure can enhance the position accuracy by using helical antennas having miniaturized meander line conductive elements (e.g., with fractal or crank line meander structures/paths disposed on helices of the separate antennas) to provide less mutual coupling and better antenna isolation, compared to conventional prior art antennas, in a location system array. The previously-noted systemic errors of the prior art are thus reduced to produce better positional accuracy.

The multi-axis helical antennas systems (arrays of helix antennas) themselves can also afford a smaller size than conventional prior art arrays, which can afford particular benefits for great appeal in venue settings, e.g., stadiums, arenas, etc.

An exemplary embodiment, for example, operates at the 2.4 GHz ISM band or other ISM frequency bands. Exemplary embodiments can operate in the Citizens Broadband Radio Service (CBRS) band, which is a part of the mid-band spectrum and is used for wireless communications; the CBRS band is a 150 MHz slice of the 3.5 GHz band, which is between 3.55 and 3.7 GHZ.

When many such multi-axis helical antenna arrays according to the present disclosure are set up in a room or structure (e.g., on the ceiling of a building, stadium, etc.), the data on each array, can be combined in an ensemble solution for the three dimensional (3D) position of an external transmitting source such as a cellular device, smart phone, etc. Knowing that position, specific information may also be targeted and sent to that specific source with that source's receiver. Hence the multi-axis spiral antenna systems can function as and enables “spatial computers” that functions to address particular RF sources. An example of said external transmitting source can be a cell phone, e.g., within a large venue such as an office building or a stadium. Additional cell phone may likewise be targeted, allowing an ensemble of cell phones to be spatially located and targeted (individually or in groups) for information and position.

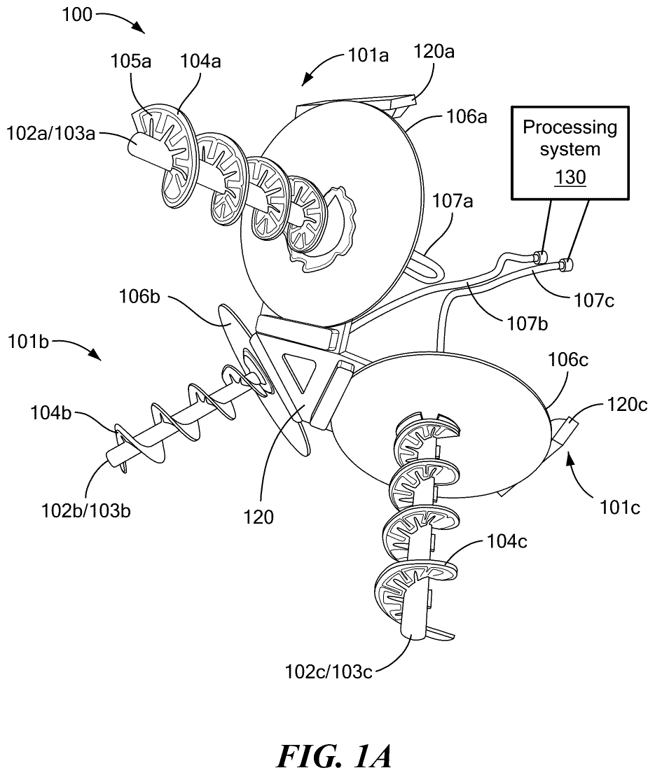

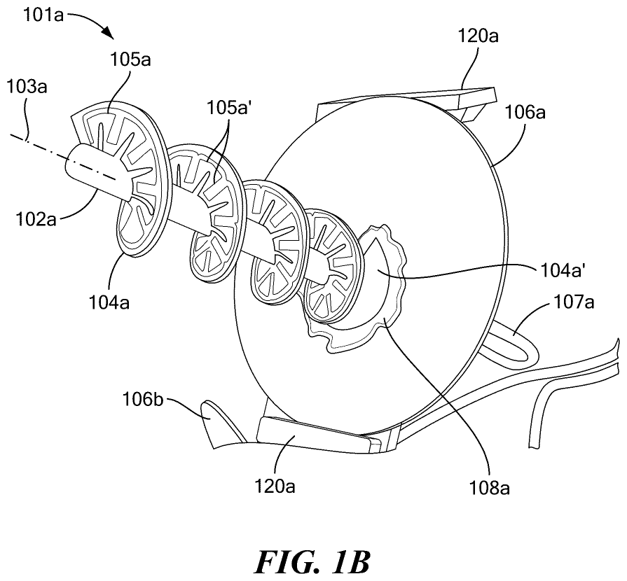

FIG. 1A shows an example multi-axis helical antenna system (apparatus) 100 in accordance with the present disclosure. The antenna system 100 includes a plurality of helical antennas (as indicated by three antennas 101a-101c), which are offset from one another by angles (angular displacement). The antennas 101a-101c include central frame elements 102a-102c, respectively, defining central or longitudinal axes 103a-103c, respectively. Antennas 101a-101c include spiral threads or faces 104a-104c, respectively, connected to or integral with the central frame elements 102a-102b. Helical conductive elements or helices 105a-105c, respectively, can be disposed on or connected to the spiral threads/faces 104a-104c, respectively. The pitch of the spiral threads/faces 104a-104c may be selected as desired, e.g., to suit a particular desired frequency range of operation. In some embodiments, the central frame elements 102a-102c and spiral structures (threads/faces) 104a-104c may be made of or include one or more suitable plastics. The helices 105a-105c may be formed from suitable conductive elements, e.g., printed circuit boards having conductive traces.

The angle between each pair of antennas (e.g., 101a-101b)—as measured between the respective central axes—can be selected as desired. In some embodiments, the angles between pairs of antennas may be between about 15 degrees and about 60 degrees; in some embodiments, the angles between pairs of antennas may be between about 20 degrees and about 40 degrees; of course, other angles may be employed. In some embodiments, the angles between pairs of antennas 101a-101c can be equal; in other embodiments, the respective separation angles (angular offsets) can be different.

Each helix 105a-105c can be connected to additional electronic apparatus/circuitry (as indicated as processing system 130) to measure phase and infer location of RF transmitters within range of antenna system 100. The helices 105a-105c are attached to ground plane bases 106a-106c, respectively, which are all supported by a frame 120. Frame 120 can include portions 120a-120c for antenna 101a-101c, respectively, which can be joined, e.g., at a central member or region of frame 120 as shown.

Each helix, e.g., 105b, can have its own cable, e.g., 107b, to attach to electronics, e.g., as indicated by processing system 130, capable of communicating with and/or determining RF transmitter location (of transmitting RF transmitters/transceivers) from received RF signals from helical antennas 101a-101c. Processing system 130 can send additional data, e.g., including image or voice data, via the antenna system 100, to wireless devices (RF transmitters such as smart phones) located by processing system 130.

While single conductive elements or wires (monofilar helices) 105a-105c are shown for helical antennas 101a-101c, alternate embodiments of the present disclosure can utilize helical antennas with two conductive elements or wires (bifilar helices) or with four conductive elements or wires (quadrifilar helices).

The antenna system 100 can take advantage of the angular offsets of each antenna on the base, to measure the gain variations of a target transmitting source between each of the antenna pairs. The null between one antenna and another in an antenna pair (pairing) allows for a precise measure of angular position of an external transmitting source (e.g., mobile cellular device) via the sharp gradient of power pattern as a function of angle. Hence each antenna pair, e.g., 101a-101b, allows for six separate antenna gradient measurements (one for each antenna and one for each pair of antennas) and three paired gradient measurements (each pair of separate receivers looking at mutual gain as function of position of target).

Knowing the specific location of an RF target (transmitting source), e.g., a mobile device such as a smart phone, specific (or general) information can be targeted for and sent to that RF target. This is so as each RF target, for the case of mobile phones, has an ISP address (number). Locating an RF target by use of the tri-axial antenna system 100, discerning the ISP address of the RF target, and then transmitting date to the so identified ISP address can accomplish targeted data transmission to that RF target (e.g., mobile device). Such a process can enable spatial addressing (as a “spatial computer”), within the area of reception of antenna system 100, to target and send information to one or more specific RF sources in range of antenna system 100. Two or more systems similar to antenna system 100 can enable spatial addressing, with high precision of location determination, within an area or volume larger than the reception area/volume of a single multi-axis antenna system.

While antennas 101a-101c are configured (on frame 120) such that the antenna axes 103a-103c intersect at a point (or within a small enough region to be regarded as a point), antenna axes in other embodiments may not necessarily intersect.

When many such arrays, e.g., multiple instances of multi-axis antenna system 100, are set up in a room or structure (e.g., a building, stadium, etc.), say on the ceiling, the data on each array, combine in an ensemble solution for the three dimensional (3D) position of an external transmitting source. Knowing that position, specific information may also be targeted and sent to that specific source with that source's receiver. Hence the system can function as a (and enables) a “spatial computer.” As noted above, an example of an external transmitting source can be a cell phone, e.g., within a large venue such as an office building or a stadium. Additional cell phone may likewise be targeted, allowing an ensemble of cell phones to be spatially located and targeted (individually or in groups) for information and position.

FIG. 1B is an enlarged view of one spiral antenna 101a of the antenna system 100 shown in FIG. 1A. As shown, a portion 104a′ of spiral face 104a can be connected to ground plane base 106a, e.g., as facilitated by dielectric adhesive 108a. Helix 105a is shown having a meander line configuration (design) 105a′ shaped as a crank line meander; in other embodiments helix 105a may have a suitable fractal (or other) configuration. Examples of suitable fractal shapes for configuration 105a′ are shown and described in co-owned U.S. Pat. No. 6,452,553, the entire content of which is incorporated herein by reference. A portion of central axis 103a is also indicated.

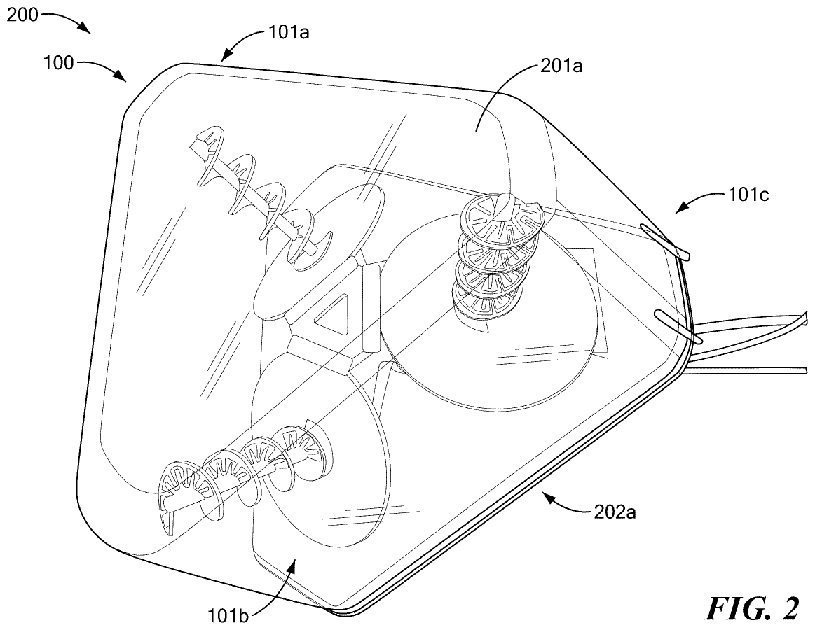

FIG. 2 shows another example antenna system 200, in accordance with the present disclosure. System 200 is similar to system 100 of FIGS. 1A-1B, and shares the same reference numbers, but also includes a radome 201 and base 202 for protection of and/or hiding the associated antennas 101a-101c.

Radome 201 and/or base 202 can be made of any suitable material(s) that are non-conductive, transparent to radio frequency (RF) signals, and protect the antennas 101a-101c from weather and/or inadvertent physical contact. Examples of suitable materials include but are not limited to: fiberglass; Polycarbonate; acrylonitrile butadiene styrene (ABS); polyetherimide (PEI), a.k.a., Ultem; G10/FR-4 glass epoxy; and/or Polytetrafluoroethylene (PTFE).

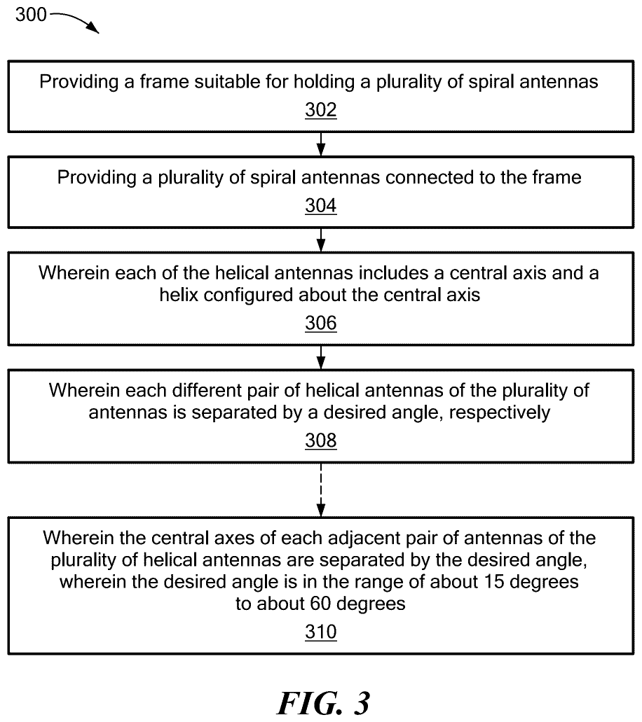

FIG. 3 is a diagram showing steps in an example method 300 of fabricating a [add], in accordance with the present disclosure. As shown, method 300 can include providing a frame suitable for holding a plurality of spiral antennas, as described at 302. A plurality of spiral antennas connected to the frame can be provided as described at 304. Each of the helical antennas can include a central axis and a helix configured about the central axis, as described at 306. Each different pair of helical antennas of the plurality of antennas can be separated by a desired angle, respectively as described at 308. In some embodiments, the central axes of each adjacent pair of antennas of the plurality of helical antennas can be separated by the desired angle, wherein the desired angle is in the range of about 15 degrees to about 60 degrees as described at 302.

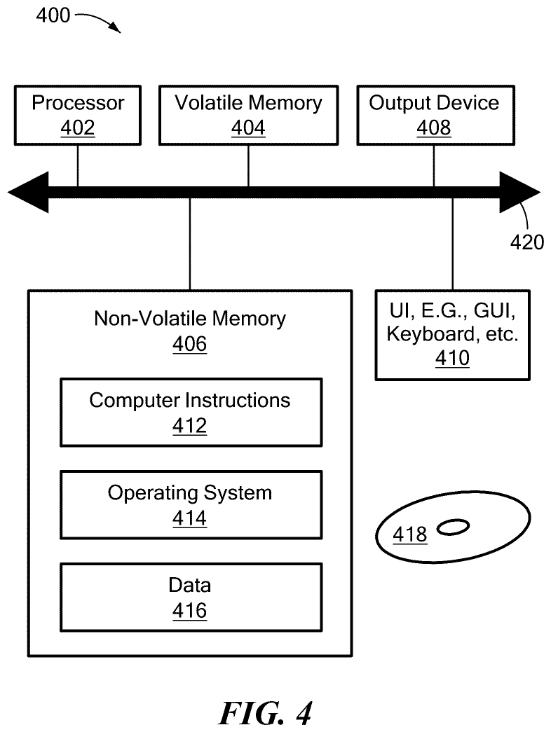

FIG. 4 shows an example computing (processing) system 400, in accordance with the present disclosure. System 400 (and/or similar or equivalent systems) can perform all or at least a portion of the processing, e.g., steps in the algorithms and methods as described herein. Such processing can include but is not limited to: facilitating and/or performing radio location of one or more RF sources in range of a multi-axis helical antenna in accordance with the present disclosure, and/or communication with (transmission to and/or reception from using any one or more well-known air interface protocols or standards) one or more RF sources in range of a multi-axis helical antenna in accordance with the present disclosure. Some embodiments of system 400 can include, be connected to, or be included in processing system 130 of FIG. 1A.

The computer system 400 can includes a processor 402, a volatile memory 404, a non-volatile memory 406 (e.g., hard disk), an output device 408 and a user input or interface (UI) 410, e.g., graphical user interface (GUI), a mouse, a keyboard, a display, and/or any common user interface, etc. The non-volatile memory (non-transitory storage medium) 406 stores computer instructions 412 (a.k.a., machine-readable instructions or computer-readable instructions) such as software (computer program product), an operating system 414 and data 416. In one example, the computer instructions 412 are executed by the processor 402 out of (from) volatile memory 404. In one embodiment, an article/apparatus 418 (e.g., a storage device or medium such as a hard disk, an optical disc, magnetic storage tape, optical storage tape, flash drive, etc.) includes or stores the non-transitory computer-readable instructions.

Processing may be implemented in hardware, software, or a combination of the two. Processing may be implemented in computer programs executed on programmable computers/machines that each includes a processor, a storage medium or other article of manufacture that is readable by the processor (including volatile and non-volatile memory and/or storage elements), and optionally at least one input device, and one or more output devices. Program code may be applied to data entered using an input device or input connection (e.g., port or bus) to perform processing and to generate output information.

The system 400 can perform processing, at least in part, via a computer program product, (e.g., in a machine-readable storage device), for execution by, or to control the operation of, data processing apparatus (e.g., a programmable processor, a computer, or multiple computers). Each such program may be implemented in a high-level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer. Processing may also be implemented as a machine-readable storage medium, configured with a computer program, where upon execution, instructions in the computer program cause the computer to operate.

Processing may be performed by one or more programmable processors executing one or more computer programs to perform the functions of the system. All or part of the system may be implemented as special purpose logic circuitry, e.g., an FPGA (field programmable gate array) and/or an ASIC (application-specific integrated circuit).

Various embodiments of the concepts, systems, devices, structures, and techniques sought to be protected are described above with reference to the related drawings. Alternative embodiments can be devised without departing from the scope of the concepts, systems, devices, structures, and techniques described herein. For example, in some embodiments, bifilar or quadrifilar helical antennas may be used etc. Moreover, while embodiments of the present disclosure have been described above and shown in the accompanying figures as helical coils having certain shapes, other alternate shapes may be used within the scope of the present disclosure.

It is noted that various connections and positional relationships (e.g., over, below, adjacent, etc.) may be used to describe elements and components in the description and drawings. These connections and/or positional relationships, unless specified otherwise, can be direct or indirect, and the described concepts, systems, devices, structures, and techniques are not intended to be limiting in this respect. Accordingly, a coupling of entities can refer to either a direct or an indirect coupling, and a positional relationship between entities can be a direct or indirect positional relationship.

As an example of an indirect positional relationship, positioning element “A” over element “B” can include situations in which one or more intermediate elements (e.g., element “C”) is between elements “A” and elements “B” as long as the relevant characteristics and functionalities of elements “A” and “B” are not substantially changed by the intermediate element(s).

Also, the following definitions and abbreviations are to be used for the interpretation of the claims and the specification. The terms “comprise,” “comprises,” “comprising,” “include,” “includes,” “including,” “has,” “having,” “contains” or “containing,” or any other variation are intended to cover a non-exclusive inclusion. For example, an apparatus, a method, a composition, a mixture, or an article, which includes a list of elements is not necessarily limited to only those elements but can include other elements not expressly listed or inherent to such apparatus, method, composition, mixture, or article.

Additionally, the term “exemplary” means “serving as an example, instance, or illustration.” Any embodiment or design described as “exemplary” is not necessarily to be construed as preferred or advantageous over other embodiments or designs. The terms “one or more,” and “at least one” may indicate any integer number greater than or equal to one, i.e., one, two, three, four, etc.; those terms, however, may refer to fractional numbers/values where context admits. The term “plurality” any integer or fractional (e.g., decimal) number greater than one. The term “connection” can include an indirect connection and/or a direct connection.

References in the specification to “embodiments,” “one embodiment, “an embodiment,” “an example embodiment,” “an example,” “an instance,” “an aspect,” etc., indicate that the embodiment described can include a particular feature, structure, or characteristic, but every embodiment may or may not include the particular feature, structure, or characteristic. Moreover, such phrases do not necessarily refer to the same embodiment. Further, when a particular feature, structure, or characteristic is described in connection with an embodiment, it may affect such feature, structure, or characteristic in other embodiments whether explicitly described or not.

Relative or positional terms including, but not limited to, the terms “upper,” “lower,” “right,” “left,” “vertical,” “horizontal, “top,” “bottom,” and derivatives of those terms relate to the described structures and methods as oriented in the drawing figures. The terms “overlying,” “atop,” “on top, “positioned on” or “positioned atop” mean that a first element, such as a first structure, is present on a second element, such as a second structure, where intervening elements such as an interface structure (interfacing structure) can be present between the first element and the second element. The term “direct contact” means that a first element, such as a first structure, and a second element, such as a second structure, are connected without any intermediary elements.

Use of ordinal terms such as “first,” “second,” “third,” etc., in the claims to modify a claim element does not by itself connote any priority, precedence, or order of one claim element over another, or a temporal order in which acts of a method are performed but are used merely as labels to distinguish one claim element having a certain name from another element having a same name (but for use of the ordinal term) to distinguish the claim elements.

The terms “approximately” and “about” may be used to mean within ±20% of a target (or nominal) value in some embodiments, within plus or minus (±) 10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

The disclosed subject matter is not limited in its application to the details of construction and to the arrangements of the components set forth in the following description or illustrated in the drawings. The disclosed subject matter is capable of other embodiments and of being practiced and implemented in various ways.

Also, the phraseology and terminology used in this patent are for the purpose of description and should not be regarded as limiting. As such, the conception upon which this disclosure is based may readily be utilized as a basis for the designing of other structures, methods, and systems for carrying out the several purposes of the disclosed subject matter. Therefore, the claims should be regarded as including such equivalent constructions as far as they do not depart from the spirit and scope of the disclosed subject matter.

Although the disclosed subject matter has been described and illustrated in the foregoing exemplary embodiments, the present disclosure has been made only by way of example. Thus, numerous changes in the details of implementation of the disclosed subject matter may be made without departing from the spirit and scope of the disclosed subject matter.

Accordingly, the scope of this patent should not be limited to the described implementations but rather should be limited only by the spirit and scope of the following claims. All publications and references cited in this patent are expressly incorporated by reference in their entirety.

What is claimed is:

1. A multi-axis helical antenna system comprising:
a frame; and
a plurality of helical antennas connected to the frame, wherein each of the helical antennas includes a central axis and a helix configured about the central axis, and wherein each different pair of helical antennas of the plurality of antennas is separated by a desired angle, respectively.

2. The antenna system of claim 1, wherein the plurality of helical antennas is configured for an end-fire radiation mode.

3. The antenna system of claim 1, wherein the central axes of each adjacent pair of antennas of the plurality of helical antennas is separated by the desired angle, wherein the desired angle is in the range of about 15 degrees to about 60 degrees.

4. The antenna system of claim 1, wherein the plurality of helical antennas includes three helical antennas.

5. The antenna system of claim 1, wherein the plurality of helical antennas is configured such that in operation the antennas are substantially decoupled from one another.

6. The antenna system of claim 1, wherein each helix includes a crank line or fractal meander line configuration.

7. The antenna system of claim 1, further comprising transmission circuitry configured to supply each of the plurality of helical antennas with RF energy for transmission.

8. The antenna system of claim 1, further comprising processing circuitry configured to transmit data to one or more targeted RF sources within range of the plurality of helical antennas.

9. The antenna system of claim 8, wherein the processing circuitry is further configured to utilize an ISP address for each of the one or more targeted RF sources for data transmission.

10. The antenna system of claim 1, further comprising reception circuitry configured to receive RF energy from one or more target RF sources within range of the plurality of helical antennas.

11. The antenna system of claim 10, further comprising processing circuitry configured to produce an output signal indicative of a location of one or more RF targets within range of the plurality of helical antennas.

12. A method of making a multi-axis helical antenna system, the method comprising:
providing a frame; and
providing a plurality of helical antennas connected to the frame, wherein each of the helical antennas includes a central axis and a helix configured about the central axis, and wherein each different pair of helical antennas of the plurality of antennas is separated by a desired angle, respectively.

13. The method of claim 12, wherein the plurality of helical antennas is configured for an end-fire radiation mode.

14. The method of claim 12, wherein the central axes of each adjacent pair of antennas of the plurality of helical antennas is separated by the desired angle, wherein the desired angle is in the range of about 15 degrees to about 60 degrees.

15. The method of claim 12, wherein the plurality of helical antennas includes three helical antennas.

16. The method of claim 12, wherein the plurality of helical antennas is configured such that in operation the antennas are substantially decoupled from one another.

17. The method of claim 12, wherein each helix includes a crank line or fractal meander line configuration.

18. The method of claim 12, further comprising providing transmission circuitry configured to supply each of the plurality of helical antennas with RF energy for transmission.

19. The method of claim 12, further comprising providing processing circuitry configured to transmit data to one or more targeted RF sources within range of the plurality of helical antennas.

20. The method of claim 12, further comprising providing reception circuitry configured to receive RF energy from one or more target RF sources within range of the plurality of helical antennas.

21. The method of claim 20, further comprising providing processing circuitry configured to produce an output signal indicative of a location of one or more RF targets within range of the plurality of helical antennas.
